(19) United States
(12) Patent Application Publication
(10) Pub. No.: US 2003/0236085 A1
(43) Pub. Date: Dec. 25, 2003

(54) Method for synchronizing a security start value in a wireless communications network

(76) Inventor: Chi-Fong Ho, Hsin-Chu Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/250,183

(22) Filed: Jun. 10, 2003

Related U.S. Application Data
(60) Provisional application No. 60/319,333, filed on Jun. 21, 2002.

(51) Int. Cl. H04M 1/66

(52) U.S. Cl. 455/411; 455/414.1

(57) ABSTRACT

In a 3GPP system, a UE can process two RRC messages independently of each other, each of which may contain a START value for the same domain. To avoid loss of synchronization between the UE and the UTRAN with respect to these START values, in a first embodiment a UE ensures that the START values in the two messages are identical if the first message has not been fully acknowledged before the transmitting of the second message. In a second embodiment, the UTRAN only updates its “most recently received” START value if the message from the UE contains a greater-valued START value. In a third embodiment, only START values as embedded within a INITIAL DIRECT TRANSFER message are utilized by both the UE and the UTRAN in a Security Mode procedure.

### CROSS REFERENCE TO RELATED APPLICATIONS

This application claims the benefit of U.S. Provisional Application No. 60/319,333, filed Jun. 21, 2002, and included herein by reference.

### BACKGROUND OF INVENTION

1. Field of the Invention

The present invention relates to a method for synchronizing a START value between two entities in a 3GPP wireless system, the START value being used for security purposes. In particular, the present invention provides for START value synchronization during simultaneous processing of two RRC messages that each contains a START value for the same domain.

2. Description of the Prior Art

Please refer to FIG. 1. FIG. 1 is a simple block diagram of a wireless communications network 10, as defined by the 3^{rd} Generation Partnership Project (3GPP) specifications 3GPP TS 25.322 V3.10.0 “RLC Protocol Specification”, and 3GPP TS 25.331 V3.10.0 “Radio Resource Control (RRC) Specification”, which are included herein by reference. The wireless communications network 10 comprises a plurality of radio network subsystems (RNSs) 20r in communications with a core network (CN) 30. The plurality of RNSs 20r is termed a Universal Mobile Telecommunications System (UMTS) Terrestrial Radio Access Network, or UTRAN 20 for short. Each RNS 20r comprises one radio network controller (RNC) 29 that is in communications with a plurality of Node Bs 24. Each Node B 24 is a transceiver, which is adapted to send and receive wireless signals, and which defines a cell region. A plurality of Node Bs 24 together defines a UTRAN Registration Area (URA). In particular, the wireless communications network 10 assigns a mobile unit 40 (generally termed a “UE” for User Equipment) to a particular RNS 20r, which is then termed the serving RNS (SRNS) 20s of the UE 40. Data destined for the UE 40 is sent by the CN 30 (or UTRAN 20) to the SRNS 20s. It is convenient to think of this data as being sent in the form of one or more packets that have a specific data structure, and which travel along one of a plurality of radio bearers (RBs) 28, 48. An RB 48 established on the UE 40 will have a corresponding RB 28 established on the SRNS 20s. The RBs are numbered consecutively, from RB0 to RBn. Typically, RB0 to RB4 are dedicated signaling RBs (SRBs), which are used for passing protocol signals between the UTRAN 20 and the UE 40. RBs 28, 48 greater than four (i.e., RB5, RB6, etc.) are typically used to carry user data, but may also be SRBs. Each RB 28, 48 is associated with one domain within the CN 30. Currently, two domains exist: a packet switched (PS) domain 30p, and a circuit switched (CS) domain 30c. The RNC 29 utilizes a Node B 24, which may be assigned to the UE 40 by way of a Cell Update procedure, to transmit data to, and receive data from, the UE 40. The Cell Update procedure is initiated by the UE 40 to change a cell as defined by a Node B 24, and even to change a URA. Selection of a new cell region will depend, for example, upon the location of the UE 40 within the domain of the SRNS 20s. The UE 40 broadcasts data to the wireless communications network 10, which is then picked up by the SRNS 20s and forwarded to the CN 30. Occasionally, the UE 40 may move close to the domain of another RNS 20, which is termed a drift RNS (DRNS) 20d. A Node B 24 of the DRNS 20d may pick up the signal transmitted by the UE 40. The RNC 29 of the DRNS 20d forwards the received signal to the SRNS 20s. The SRNS 20s uses this forwarded signal from the DRNS 20d, plus the corresponding signals from its own Node Bs 24 to generate a combined signal that is then decoded and finally processed into packet data. The SRNS 20s then forwards the received data to the CN 30. Consequently, all communications between the UE 40 and the CN 30 must pass through the SRNS 20s.

Please refer to FIG. 2 in conjunction with FIG. 1. FIG. 2 is a simple block diagram of a UMTS radio interface protocol architecture, as used by the communications network 10. Communications between the UE 40 and the UTRAN 20 is effected through a multi-layered communications protocol that includes a layer 1, a layer 2 and a layer 3, which together provide transport for a signaling plane (C-plane) 92 and a user plane (U-plane) 94. Layer 1 is the physical layer 60, responsible for the actual transmitting and receiving of wireless signals, and in the UTRAN 20 is responsible for combining signals received from the DRNS 20d and SRNS 20s. Layer 2 includes a packet data convergence protocol (PDCP) layer 70, a Radio Link Control (RLC) layer 72, and a Medium Access Control (MAC) layer 74. Layer 3 includes a Radio Resource Control (RRC) layer 80. The U-plane 94 handles user data transport between the UE 40 and the UTRAN 20, whereas the C-plane 92 handles transport for signaling data between the UE 40 and the 20. The RRC 80 sets up and configures all RBs 28, 48 between the UTRAN 20 and the UE 40. The PDCP layer 70 provides header compression for Service Data Units (SDUs) received from the U-plane 94. The RLC layer 72 provides segmentation of PDCP 70 SDUs, RRC 80 SDUs and U-plane 94 SDUs into RLC protocol data units (PDUs), and under acknowledged mode (AM) transfers, can provide upper layers (such as the PDCP layer 70 or the RRC layer 80) with a confirmation that RLC PDUs have been successfully transmitted and received between the UTRAN 20 and the UE 40. The MAC layer 74 provides scheduling and multiplexing of RLC PDUs onto the transport channel, interfacing with the physical layer 60.

Before proceeding, it is worth taking note of terminology used in the following. An SDU is any packet that is received from an upper layer or passed to an upper layer, whereas a PDU is a packet generated by a layer and passed on to a lower layer or received from a lower layer. Hence, a PDCP PDU is an RLC SDU. Similarly, an RLC PDU is a MAC SDU, and so forth. Generally, a PDU is formed by adding a header to SDU data received from an upper layer, or by internally generating a packet for layer-to-layer communications between the UE 40 and the UTRAN 20. Please refer to FIG. 3 with reference to FIG. 1 and FIG. 2. FIG. 3 is a simplified block diagram of example communications between the UTRAN 20 and the UE 40. An upper layer 24 in the C-plane 92 on the UTRAN 20 needs to send data 24d to an upper layer 44 on the UE 40. The upper layer 24 connects with a layer 3 interface 23 (i.e., the RRC 80), and passes the data 24d to the layer 3 interface 23. The layer 3 interface 23 uses the data 24d to form a layer 3 protocol data unit (PDU) 23p. The layer 3 PDU 23p includes a layer 3 header 23h and data 23d, which is identical to the data 24d. The layer 3 header 23h in the layer 3 PDU 23p contains information needed by the peer layer 3 interface 33 on the UE 40 (i.e., the peer RRC layer 80) to effect proper communications. The layer 3 interface 23 then passes the layer 3 PDU 23p to the layer 2 interface 22. The layer 2 interface 22 (which includes the RLC layer 72, the PDCP layer 70 and the MAC layer 74) uses the layer 3 PDU 23p to build one or more layer 2 PDUs 22p. Generally speaking, each layer 2 PDU 22p has the same fixed size, which is determined by the MAC layer 74. Consequently, if the layer 3 PDU 23p is quite large, the layer 3 PDU 23p will be segmented by the layer 2 interface 22 to form several layer 2 PDUs 22p, as is shown in FIG. 3. Each layer 2 PDU 22p contains a data region 22d, and a layer 2 header 22h. In FIG. 3, the data 23d has been broken into two layer 2 PDUs 22p. Also note that the layer 3 header 23h is placed in the data region 22d of a layer 2 PDU 22p. The layer 3 header 23h holds no significance for layer 2 interface 22, and is simply treated as data. The layer 2 interface 22 then passes the layer 2 PDUs 22p to the layer 1 interface 21. The layer 1 interface 21 accepts the layer 2 PDUs 22p and uses them to build layer 1 PDUs 21p. As with the preceding layers, each layer 1 PDU 21p has a data region 21d and a layer 1 header 21h. Note that the layer 3 header 23h and layer 2 headers 22h are no more important to the layer 1 interface 21 than the application data 24d. The layer 1 interface 21 then transmits the layer 1 PDUs 21p to the UE 40.

A reverse process occurs on the UE 40. After receiving layer 1 PDUs 41p from the UTRAN 20, the layer 1 interface 31 on the UE 40 removes the layer 1 headers 41h from each received layer 1 PDU 41p. This leaves only the layer 1 data regions 41d, which are, in effect, layer 2 PDUs. These layer 1 data regions 41d are passed up to the layer 2 interface 42. The layer 2 interface 42 accepts the layer 2 PDUs 42p and uses the layer 2 headers 42h to determine how to assemble the layer 2 PDUs 42p into appropriate layer 3 PDUs. In the example depicted in FIG. 3, the layer 2 headers 42h are stripped from the layer 2 PDUs 42p, leaving only the data regions 42d. The data regions 42d are appended to each other in the proper order, and then passed up to the layer 3 interface 43. The layer 3 interface 43 accepts the layer 3 PDU 43p from the layer 2 interface 42, strips the header 43h from the layer 3 PDU 43p; and passes the data region 43d to the upper layer 44. The upper layer44 thus has data 44d that should be identical to the data 24d sent by the upper layer24 on the UTRAN 20. Note that each layer in the communications stack can also generate packets exclusively for interlayer signaling between the UTRAN 20 and the UE 40. Hence, a frequent occurrence is the UTRAN 20 RRC layer 80 generating a signaling packet for the UE 40 RRC layer 80, and vice versa, which would be an RRC PDU. These RRC signaling PDUs, however, are never passed up to the upper layers 24, 44 as SDU data. An example of such an RRC signaling packet is a request for a ciphering reconfiguration activation, which includes a SECURITY MODE COMMAND on downlink (UTRAN 20 to UE 40) and a SECURITY MODE COMPLETE on uplink (UE 40 to UTRAN 20), and reconfiguration messages to establish and reconfigure RBs 48, 28, such as a CELL UPDATE message for the Cell Update procedure.

Of particular relevance to the present invention is the RLC layer 72 in the layer 2 stack. The RLC layer 72 generates RLC PDUs of a fixed size that is determined by the MAC layer 74, and sends these RLC PDUs to the MAC layer 74 for transmission, or receives RLC PDUs from the MAC layer 74. Each RLC PDU explicitly carries an n-bit sequence number in its header that identifies the sequential position of that RLC PDU in a stream of RLC PDUs, and which thus enables RLC PDUs to be assembled in their proper order to form RLC SDUs (i.e., PDCP PDUs, or RRC PDUs). Please refer to FIG. 4 in conjunction with FIGS. 1 to 3. FIG. 4 is simplified block diagram of an RLC layer PDU 50. The RLC PDU 50 has an RLC header 51 and a data region 55. As noted above, the data region 55 is used to carry layer 3 PDUs 23p received from the layer 3 interface 23, or to carry data received from the PDCP layer 70. The RLC header 51 includes a data/control indicator bit 52, a sequence number field 53, and additional fields 54. The additional fields 54 are not of direct relevance to the present invention, and so will not be discussed. The data/control bit 52 is used to indicate if the RLC PDU 50 is a data PDU or a control PDU. Data PDUs are used to carry upper layer data. Control PDUs are generated internally by the RLC layer 72 and are used exclusively for signaling between RLC peer entities 72. Control PDUs are thus never passed up to the RRC layer 80 or the PDCP layer 70. The sequence number field 53 contains the n-bit value that is used to reassemble the RLC PDUs 50 into upper layer PDUs. Each RLC PDU 50 is transmitted with a successively higher value in the sequence number field 53, and in this manner the RLC layer 72 knows the correct ordering of received RLC PDUs 50.

The RLC layer 72 is composed of one or more RLC entities 76. Each RLC entity 76 is individually associated with an RB 28, 48. For an RB 28 on the UTRAN 20 side, there exists an RLC entity 76 dedicated solely to that RB 28. For the same RB 48 on the UE 40 side, there similarly exists a corresponding RLC entity 76. These two corresponding RLC entities 76 for the same RB 28, 48 are termed “RLC peer entities”. The value of “n” for the n-bit sequence numbers 53 carried within the headers 51 of the RLC PDUs 50 will depend on the transport mode utilized between the RLC peer entities 76. For example, in AM transmissions, in which the RLC peer entities 76 acknowledge each RLC PDU 50 successfully received, n is 12. In other transport modes, n is 7. For communications between the UTRAN 20 and the UE 40 to be successful, it is essential that the RLC peer entities 76 be properly synchronized with each other. In particular, each RLC entity 76 contains two hyperframe numbers (HFNs): a receiving HFN (rHFN) 76r, and a transmitting HFN (tHFN) 76t. The tHFN 76t and rHFN 76r are used for ciphering and deciphering of packet data. For this ciphering/deciphering process to be successful, RLC peer entities 76 must have synchronized rHFN 76r and tHFN 76t values. In particular, the rHFN 76r of one RLC entity 76 must be identical to the tHFN of its RLC peer entity 76, and vice versa. As RLC PDUs 50 are transmitted by an RLC entity 76, the tHFN 76t steadily increases in value. As RLC PDUs 50 are received by an RLC entity 76, the rHFN 76r steadily increases in value. The rHFN 76r counts how many times rollover is detected in the sequence numbers 53 of received RLC PDUs 50. The tHFN 76t counts how many times rollover is detected in the sequence numbers 53 of transmitted RLC PDUs 50. The HFNs 76r, 76t may thus be thought of as non-transmitted high-order bits of the RLC PDU sequence numbers 53, and it is essential that these HFNs 76r, 76t are properly synchronized on the RLC peer entities 76. The bit size of the rHFN 76r and tHFN 76t values will depend upon the bit size of the RLC PDU 50 sequence number 53 bit size. As a general principle guiding the bit sizes of the HFNs 76r, 76t, the HFNs 76r, 76t are combined with the sequence numbers 53 to form a so-called COUNT-C that is 32 bits in size. The HFNs 76r, 76t are used as the high-order bits of the COUNT-C value, and the sequence number 53 of the PDU 50 is used as the low order bits. RRichardCount-I is taken care in RRC layer instead of RLC layer. This COUNT-C value is used by the RLC layer 72 to perform ciphering and deciphering of RLC PDUs 50, and the same COUNT-C valued used for the ciphering of an RLC PDU 50 must also be used for the deciphering of that RLC PDU 50. Another security function is performed, however, for SRBs, which is integrity protection. Integrity protection is performed in the RRC layer 80, and is applied only to SRBs (i.e., RB0 to RB4). Integrity protection also utilizes a count value, termed COUNT-I. COUNT-I is a 32-bit number generated from an HFN, which is maintained by the RRC layer 80, and a sequence number that is applied to each RRC message. In effect, the process is analogous to the ciphering operation that takes place in the RLC layer 72. The RRC 80 HFNs are 28 bits in size, and so the RRC PDU sequence numbers are 4 bits in size.

It is the UE 40, however, that is responsible for setting the initial values for the rHFN 76r and tHFN 76t, and this is done by way of a so-called START value. A START value is applied to an RLC entity 76, and is used to initialize the upper order bits (typically the 20 most significant bits) of the tHFN 76t and rHFN 76r. Hence, for the RLC peer entities 76 to initially be synchronized, it is important that the UE 40 and the UTRAN 20 apply the same START value to each RLC peer entity 76. Furthermore, the same START values as applied to the RLC peer entities 76 are also used to set the HFNs in the RRC layer 80 for integrity protection. Hence, for the RB 28, 48 peer entities to initially be synchronized, it is important that the UE 40 and the UTRAN 20 apply the same START value to each RLC peer entity 76, and to the RRC peers 80. Typically, the UE 40 calculates a START value by looking at all of the RBs 48 within one of the domains 30p, 30c, selecting the largest HFN value from these RBs 48 (including the HFNs in the RRC layer 80, as well as the HFNs 76r, 76t), and adding two to the value. A START value, when applied to an RB 48, 28, will thus generate a tHFN 76t and an rHFN 76r that is greater than the tHFN 76t and rHFN 76r of any other RB 48 within that domain 30p, 30c at that time. As noted earlier, the START value is also applied to the HFN in the RRC layer 80 for the RB 48, 28.

Please refer to FIG. 5. FIG. 5 is a message sequence chart foran INITIAL DIRECT TRANSFER message in the wireless communications network 10. The initial direct transfer procedure is used in the uplink (UE 40 to UTRAN 20) to establish a signalling connection. It is also used to carry an initial upper layer (NAS) message over the radio interface. In the UE 40, the initial direct transfer procedure is initiated when the upper layers request establishment of a signalling connection. This request also includes a request for the transfer of a NAS message. The Initial Direct Transfer procedure is outlined in detail in section 8.1.8 of the RRC technical specification, 3GPP TS 25.331 V3.10.0.

The INITIAL DIRECT TRANSFER message carries an upper layer message and a START value for a particular CN domain 30p, 30c from the UE 40 to the UTRAN 20. This message is transmitted on RB3 using an RLC-AM mode. That is, the RLC peer entities 76 for RB3 utilize an AM connection, so that transmitted RLC PDUs 50 are acknowledged as successfully received between the peer entities 76, which thereby provides upper layers with confirmation that their data has been successfully transmitted. If the INITIAL DIRECT TRANSFER message size is bigger than a configured RLC-AM PDU 50 size, the RLC layer 72 will segment it into a number of RLC PDUs 50. Since the transmission of this message uses the RLC-AM mode, on the UTRAN 20 side the transmission ends when the UTRAN 20 correctly receives all of the RLC-AM PDUs 50 of this message; on the UE 40 side the transmission ends when the UE 40 receives all the RLC-ACKs for this message. That is, when the UE 40 receives acknowledgement from the UTRAN 20 that all of the RLC PDUs 50 for the INITIAL DIRECT TRANSFER message were successfully received by the UTRAN 20.

A Cell Update procedure can be initiated for a variety of reasons, such as the servicing of a periodical Cell Update procedure, or due to radio link failure. The Cell Update procedure is outlined in detail in section 8.3.1 of 3GPP TS 25.331 V3.10.0. On the UE 40 side, the Cell Update procedure begins with the UE 40 transmitting the CELL UPDATE message (via a different Radio Bearer, RB0, which uses the RLC-TM mode), and ends with reception of a CELL UPDATE CONFIRM message from the UTRAN 20. The CELL UDPATE message also carries START values for all of the CN domains 30p, 30c. The Cell Update procedure is independent of the transmission of the INITIAL DIRECT TRANSFER message, and the two procedures can thus run simultaneously.

The security mode control procedure, which is used to change ciphering and integrity protection parameters, uses the “most recently transmitted” (on the UE 40 side) and the “most recently received” (on the UTRAN 20 side) START values to initialize the HFN parts 76r, 76t of the COUNT-Cs, and the HFNs of the COUNT-Is, belonging to the CN domain 30p, 30 cindicated in the SECURITY MODE COMMAND message. Details of the Security Mode Control procedure are outlined in section 8.1.12 of 3GPP TS 25.331 V3.10.0.

If a Cell Update procedure occurs during the transmission of the INITIAL DIRECT TRANSFER message, after the successful transmission of this message, the “most recently transmitted” START value on the UE side 40 may be different from the “most recently received” START value maintained on the UTRAN side 20. This will lead to ciphering and integrity protection check errors, and result in the release of the RRC connection.

An example is illustrated in FIG. 6. FIG. 6 is a message sequence chart of a prior art INITIAL DIRECT TRANSFER message overlapped with a Cell Update procedure. The UE 40 transmits an INITIAL DIRECT TRANSFER message carrying a START value START×1 to the UTRAN 20 on RB3, and this message is segmented into three RLC PDUs. Unfortunately, the third RLC PDU is lost due to poor radio conditions, which results in the UTRAN 20 not receiving the START value START×1 (this is because the RLC entity 76 will not pass up an RLC SDU until all of the RLC PDUs that compose that RLC SDU are successfully received). Assume an event occurs on the UE 40 side that initiates a Cell Update procedure. In response to the Cell Update procedure, the UE 40 calculates a new START value START×2, which may be larger than the first START value START×1. START×2 can be larger than START×1 because, between the computation of the two values, a great deal of packet traffic may be passing between the UE 40 and the UTRAN 20, resulting in HFNs (either in the RRC 80 or the RLC 72) increasing in value. After the Cell Update procedure, both the UE 40 and the UTRAN 20 regard START×2 included in the CELL UDPATE message as the “most recently transmitted” (on UE 40 side) and the “most recently received” (on the UTRAN 20 side)START values. However, after the Cell Update procedure, the UE 40 retransmits the third RLC PDU 50 that formed the INITIAL DIRECT TRANSFER message. The UTRAN 20 receives this PDU and responds with an ACK. When the UTRAN 20 receives the now-completed INITIAL DIRECT TRANSFER message, the UTRAN 20 will store START×1 included in the INITIAL DIRECT TRANSFER message as the “most recently received” START value. At this time, the START values on the UE 40 side and the UTRAN 20 side are different. If, soon afterwards, the UTRAN 20 initiates a Security Mode Control procedure, the UE 40 and the UTRAN 20 will use different START values for initializing the HFNs of the COUNT-Is and the COUNT-Cs. This will lead to ciphering and integrity protection check errors and result in the release of the RRC connection.

### SUMMARY OF INVENTION

It is therefore a primary objective of this invention to provide a method for synchronizing a START value between a UE and a UTRAN.

Briefly summarized, the preferred embodiment of the present invention discloses a method for ensuring that START values are synchronized during a Security Mode procedure between the UTRAN and a UE. In a first embodiment, the UE generates a first START value in a standard manner. The UE composes a first message containing the first START value, and transmits the first message to the UTRAN. Prior to receiving confirmation from the UTRAN of successful reception of the first message, the UE composes a second message containing the first START value. However, at the time of composing the second message, a second START value generated in the standard manner does not equal the first START value. The UE then transmits the second message to the UTRAN.

In a second embodiment, the UTRAN receives a first message containing a first START value from the UE, and compares the first START value to a most recently received START value. If the first START value is less than the most recently received START value, then the UTRAN does not utilize the first START value to change the most recently received START value. If the first START value exceeds the most recently received START value, then the most recently received START value is set to the first START value.

In a third embodiment, both the UE and the UTRAN exclusively use START values embedded in INITIAL DIRECT TRANSFER messages when performing a Security Mode procedure.

It is an advantage of the present invention that the various embodiments may be easily implemented without requiring extensive changes to the software of the UE and/or the UTRAN. The three embodiments respectively permit changes to the UE only, the UTRAN only, or to both the UE and the UTRAN, and thus offer a flexible approach to solving START value synchronization problems.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a simple block diagram of a wireless communications system.

FIG. 2 is a simple block diagram of a UMTS radio interface protocol architecture.

FIG. 3 is a simplified block diagram of example communications between a UTRAN and a UE shown in FIG. 1.

FIG. 4 is simplified block diagram of an RLC layer PDU.

FIG. 5 is a message sequence chart foran INITIAL DIRECT TRANSFER message in the wireless communications network of FIG. 1.

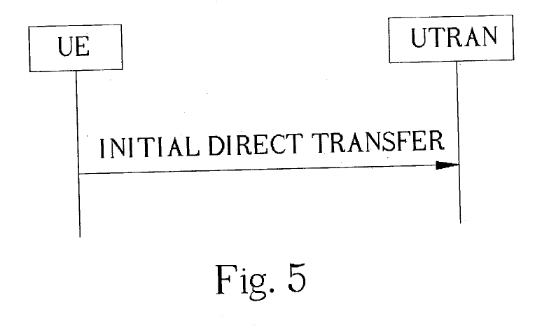

FIG. 6 is a message sequence chart of a prior art INITIAL DIRECT TRANSFER message overlapped with a Cell Update procedure according to the prior art.

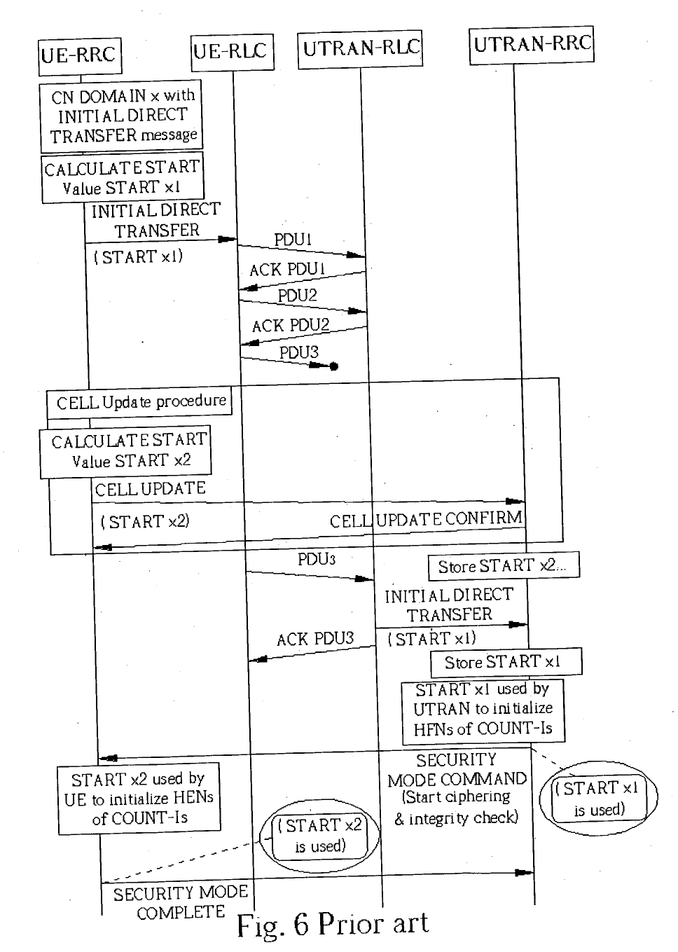

FIG. 7 is a block diagram of a wireless device according to the present invention.

FIG. 8 is a simple block diagram of a present invention first embodiment UE within a wireless communications system.

FIG. 9 is a message sequence chart for a first embodiment of the present invention method.

FIG. 10 is a simple block diagram of a present invention RNC within a second embodiment wireless communications system.

FIG. 11 is a simple block diagram of a prior art UE within the wireless communications system of FIG. 10.

FIG. 12 is a message sequence chart for the second embodiment of the present invention method.

FIG. 13 is a simple block diagram of a UE within a wireless communications system according to a third embodiment of the present invention.

FIG. 14 is a message sequence chart for the third embodiment of the present invention method.

### DETAILED DESCRIPTION

In the following description, user equipment (UE) is a wireless communications device, and may be a mobile telephone, a handheld transceiver, a personal data assistant (PDA), a computer, or any other device that requires a wireless exchange of data. It is assumed that this wireless exchange of data conforms to 3GPP-specified protocols.

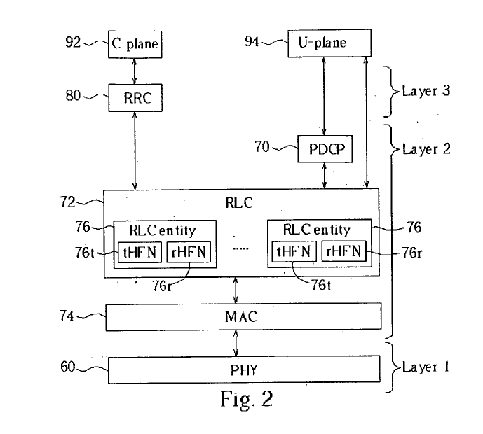

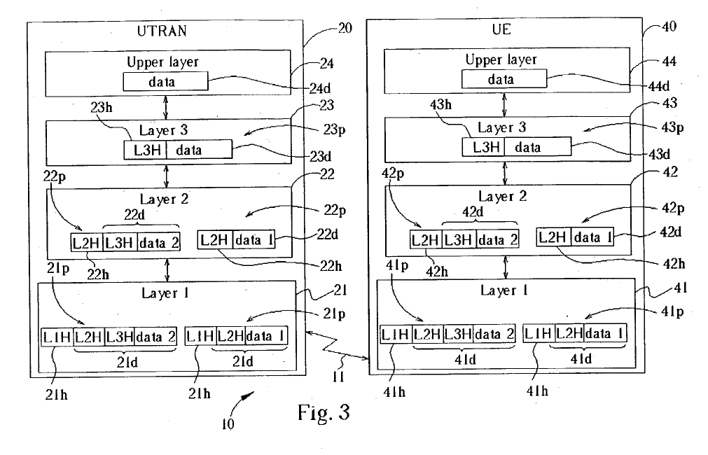

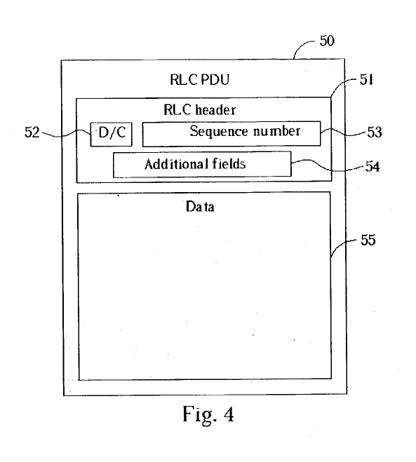

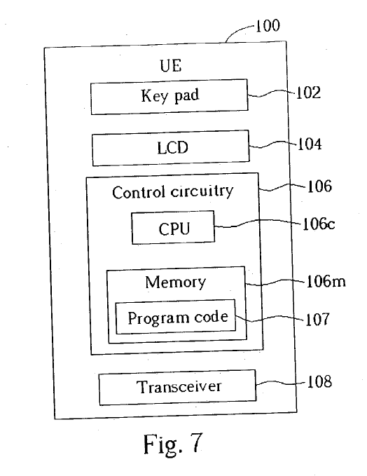

Please refer to FIG. 7. FIG. 7 is a block diagram of a wireless device according to the present invention, hereinafter termed a UE 100. In most respects, the present invention UE 100 is identical to the UE 40 of the prior art. As such, FIG. 2 to FIG. 4, which illustrate general aspects of the 3GPP communications protocol, are also suitable for providing illustration of the present invention method. The UE 100 includes devices for accepting input and providing output, such as a keypad 102 and a liquid crystal display (LCD) 104, respectively. A transceiver 108 is capable of receiving wireless signals and providing corresponding data to a control circuit 106, and can also wirelessly transmit data received from the control circuit 106. The transceiver 108 is thus part of the layer 1 stack 60 of the present invention communications protocol. The control circuitry 106 is responsible for controlling the operations of the UE 100, and is used to implement the layer 2 and layer 3 stacks of the communications protocol. To this end, the control circuitry 106 includes a central processing unit (CPU) 106c in electrical communication with memory 106m, an arrangement familiar to those in the art of wireless communication devices. The memory 106m holds program code 107 that is used to implement the layer 2 and layer 3 stacks of the 3GPP communications protocol as shown in FIG. 2. With respect to the UE 40 of the prior art, the present invention UE 100 has modifications to the program code 107 to implement the present invention method. These modifications should be well within the means of one reasonably skilled in the art after reading the following detailed description.

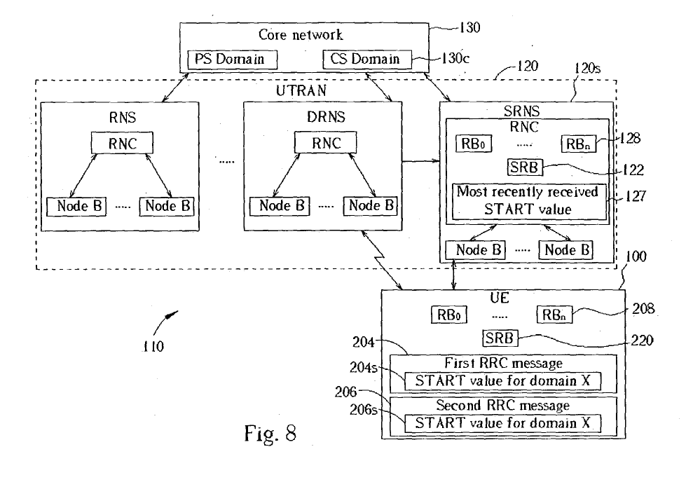

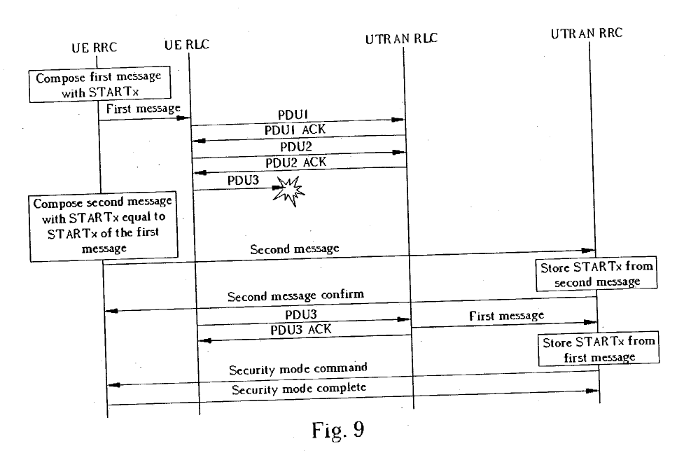

In the first embodiment method, during the transmission of any RRC message that includes a START value and that uses the RLC-AM mode (such as the INITIAL DIRECT TRANSFER message), the UE 100 should use the same START value for any new RRC message (such as the CELL UPDATE message) transmitted to UTRAN before the reception of all RLC-ACKs for the previous RRC message. Please refer to FIG. 8 and FIG. 9. FIG. 8 is a simple block diagram of the UE 100 within a wireless communications system 110. FIG. 9 is a message sequence chart illustrating the first embodiment method. The UE 100 has established an SRB 202, which utilizes an RLC-AM connection, and which has a peer SRB 122 on the UTRAN 120 side. Initially, the UE 100 composes a first RRC message 204, such as an INITIAL DIRECT TRANSFER message. The first RRC message 204 contains a START value 204s for a domain x, which may be either the PS domain 130p or the CS domain 130c within the CN 130. The START value 204s is calculated in the normal manner; that is, by considering all RBs 208 within the domain x, selecting the greatest HFN (including RLC 72 HFNs 76r, 76t, and RRC 80 HFNs) from all of these RBs 208, and adding two to the value to generate the START value 204s. The RRC layer 80 then sends the first RRC message 204 to the RLC layer 72 for transmission to the UTRAN 120. The RLC layer 72 breaks the RRC message 204 into one or more RLC-AM PDUs 50, and transmits these RLC-AM PDUs 50 to the UTRAN 120 along the SRB 202. Each successfully received RLC-AM PDU 50 is acknowledged by the peer SRB 122. By way of example, it is then assumed that the first RRC message 204 is segmented into three RLC-AM PDUs 50, two of which are successfully transmitted and acknowledged, and the third of which is lost in transmission and so not acknowledged. At some time after the third RLC-AM PDU 50 is lost, the RRC layer 80 of the UE 100 composes a second RRC message 206, which also contains a START value 206s for the domain x (such as a CELL UPDATE message). Normally, the RRC layer 80 would calculate the START values 206s in the normal manner, and would thereby probably generate a value larger than the START value 204s in the first RRC message 204. However, under the first embodiment method, the RRC layer 80 does not perform a standard START value calculation for the START value 206s because not all of the RLC-AM PDUs 50 for the first RRC message 204 have been acknowledged by the UTRAN 120. While there are RLC-AM PDUs 50 for the first RRC message that are still outstanding as regards being acknowledged by the UTRAN 120, the RRC layer 80 in the UE 100 will instead use the START value 204s as found in the first RRC message 204 for the START value 206s in the subsequent second RRC message 206s. Hence, the START values 204s and 206s are identical, regardless of what may be the actual values of the HFNs within the domain x at the time that the second RRC message 206 is composed by the UE 100 RRC layer 80. The second RRC message 206 is then sent by the UE 100 to the UTRAN 120, and subsequently confirmed by the UTRAN 120. The UTRAN stores the START value 206sheld within the second RRC message 206 as a “most recently received” START value 127. Thereafter, the third and final RLC-AM PDU 50 of the first RRC message 204 is finally successfully transmitted to the UTRAN 120 and acknowledged. The UTRAN 120 thus receives the first RRC message 204 after the second RRC message 206, and hence stores the START value 204s from the first RRC message 204 as the “most recently received” START value 127. A Security Mode Command procedure is the initiated by the UTRAN 120, upon which the UTRAN 120 will apply the “most recently received” START value 127, and so use the START value 204s from the first RRC message 204 to set the HFNs for the COUNT-C and COUNT-I values of the RBs 128, 122 within the domain x. The UE 100, however, will use the START value 206s from the second RRC message 206 to set the HFNs of the COUNT-C and COUNT-I values within the domain x, as the START value 206s is the “most recently transmitted” START value for the UE 100. This is not a problem, though, as the two START values 204s and 206s are identical. Ciphering and integrity protection will thus perform successfully within domain x.

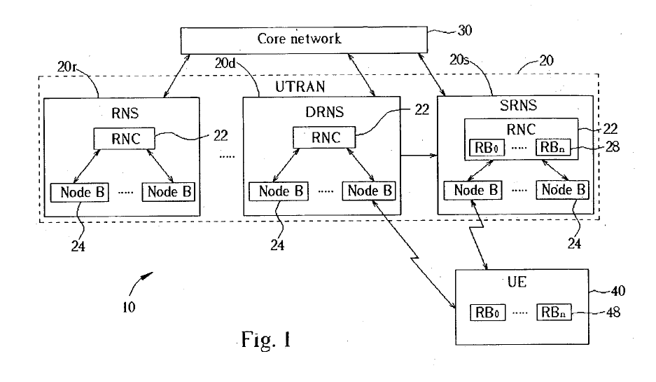

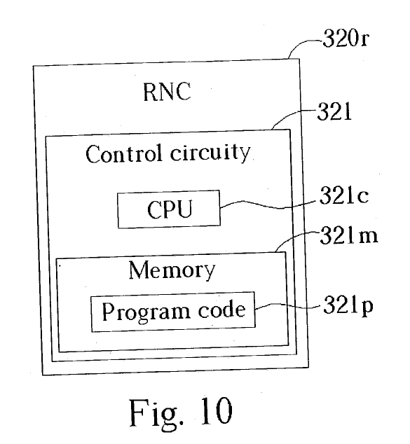

Please refer to FIG. 10. FIG. 10 is a block diagram of an RNC 320r according to a second embodiment of the present invention. In most respects, the invention RNC 320r is identical to the RNC 22 of the prior art. As such, FIG. 2 to FIG. 4, which illustrate general aspects of the 3GPP communications protocol, are also suitable for providing illustration of the second embodiment invention method. The RNC 320r is adapted to control a plurality of Node Bs 24 (as indicated in FIG. 1), and contains control circuitry 321 that is responsible for controlling the operations of the RNC 320r. The control circuitry 321 is used to implement the layer 2 and layer 3 stacks of the 3GPP communications protocol. To this end, the control circuitry 321 includes a central processing unit (CPU) 321c in electrical communication with memory 321m, an arrangement familiar to those in the art of wireless communication devices. The memory 321m holds program code 321p that is used to implement the layer 2 and layer 3 stacks of the 3GPP communications protocol as shown in FIG. 2. With respect to the RNC 22 of the prior art, the present invention RNC 320r has modifications to the program code 321p to implement the present invention method. These modifications should be well within the means of one reasonably skilled in the art after reading the following detailed description.

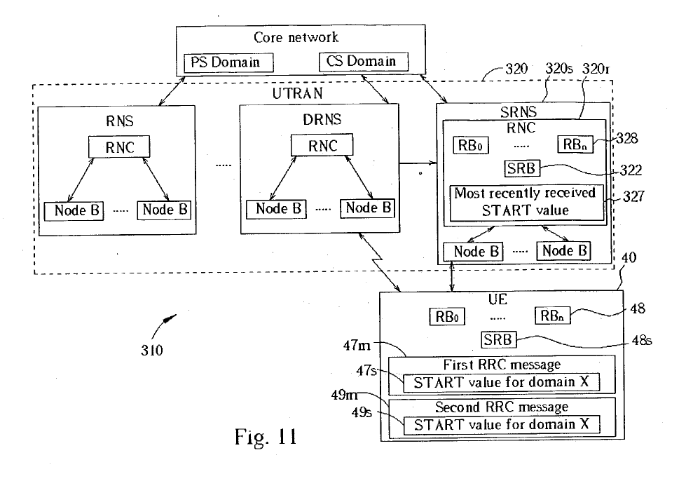

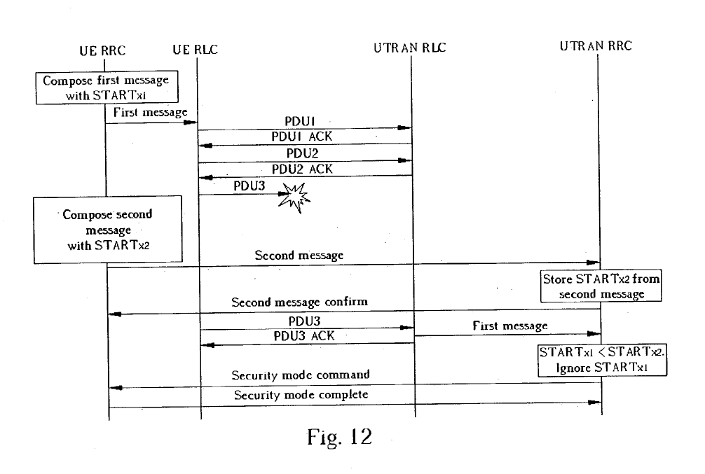

In the second embodiment method, the UTRAN only stores the START value included in a received message as the “most recently received” START value if that START value is greater than the old “most recently received” START value. Please refer to FIG. 11 and FIG. 12 with reference to FIG. 10. FIG. 11 is a simple block diagram of a prior art UE 40 within a present invention wireless communications system 310. FIG. 12 is a message sequence chart illustrating the second embodiment method. As the behavior of the invention RNC 320r differs from that of the prior art RNC 22, a UTRAN 320 composed of such RNCs 320r will similarly behave differently from the UTRAN 20 of the prior art, and hence the invention wireless communications system 310 will differ from that of the prior art wireless system 10. In the second embodiment method, the prior art UE 40 is assumed to be in wireless communications with the present invention UTRAN 320. The UE 40 has established an SRB 48s, which utilizes an RLC-AM connection, and which has a peer SRB 328s on the UTRAN 320 side. Initially, the UE 40 composes a first RRC message 47m, such as an INITIAL DIRECT TRANSFER message. The first RRC message 47m contains a START value 47s for a domain x, which may be either the PS domain 130p or the CS domain 130c within the CN 130. The START value 47s is calculated in the normal manner; that is, by considering all RBs 48 within the domain x, selecting the greatest HFN (including RLC 72 HFNs 76r, 76t, and RRC 80 HFNs) from all of these RBs 48, and adding two to the value to generate the START value 47s. The RRC layer 80 then sends the first RRC message 47m to the RLC layer 72 for transmission to the UTRAN 320 (and, by extension, the present invention RNC 320r). The RLC layer 72 breaks the RRC message 47m into one or more RLC-AM PDUs 50, and transmits these RLC-AM PDUs 50 to the UTRAN 320 along the SRB 48s. Each successfully received RLC-AM PDU 50 is acknowledged by the peer SRB 328s. As in the previous examples, it is assumed that the first RRC message 47m is segmented into three RLC-AM PDUs 50, two of which are successfully transmitted and acknowledged, and the third of which is lost in transmission and so not acknowledged. At some time after the third RLC-AM PDU 50 is lost, the RRC layer 80 of the UE 40 composes a second RRC message 49m, which also contains a START value 49s for the domain x (such as a CELL UPDATE message). The RRC layer 80 of the UE 40 calculates the START value 49s in the normal manner, and thus generates a value larger than the START value 47s in the first RRC message 47m. The second RRC message 49m is then sent by the UE 40 to the UTRAN 320, and subsequently confirmed by the UTRAN 320. The UTRAN 320 stores the START value 49s held within the second RRC message 49m as the “most recently received” START value 327. Thereafter, the third and final RLC-AM PDU 50 of the first RRC message 47m is finally successfully transmitted to the UTRAN 320 and acknowledged. The UTRAN 320 thus receives the first RRC message 47m after the second RRC message 49m. However, rather than immediately storing the START value 47s from the first RRC message 47m as the “most recently received” START value 327, the UTRAN 320 instead checks the current value of the “most recently received” START value 327. If the “most recently received” START value 327 is greater than a START value received in a message, then the START value received in the message is not used as the “most recently received” START value 327. In this case, the START value 47s in the first RRC message 47m is less than the “most recently received” START value 327. The UTRAN 320 thus ignores the START value 47s contained within the first RRC message 47m. Hence, the “most recently received” START value 327 continues to have the same value as the START value 49s contained within the second RRC message 49m. The “most recently received” START value 327 is thus more properly a “greatest previously received” START value. A Security Mode Command procedure is subsequently initiated by the UTRAN 320, upon which the UTRAN 320 applies the “most recently received” START value 327, which is the START value 49s from the second RRC message 49m, to set the HFNs for the COUNT-C and COUNT-I values of the RBs 328, 328s within the domain x. The UE 40 also uses the START value 49s from the second RRC message 49m to set the HFNs of the COUNT-C and COUNT-I values Within the domain x, as this is the “most recently transmitted” START value of the UE 40. Ciphering and integrity protection thus perform successfully within domain x.

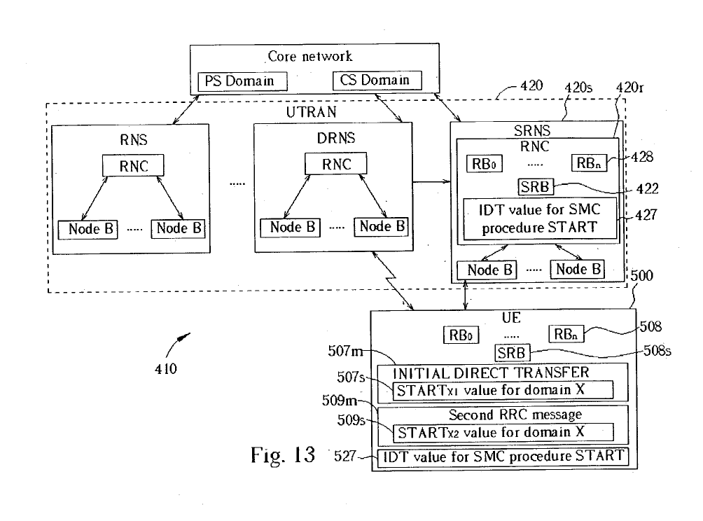

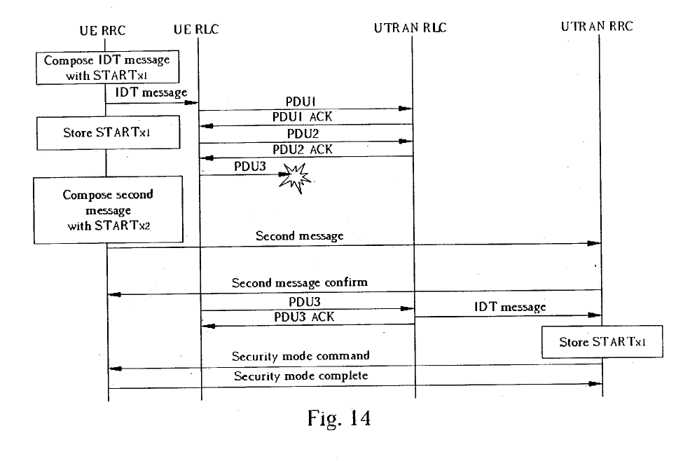

In the third embodiment of the present invention method, rather than using the “most recently transmitted” and “most recent received” START values for HFN initialization in a security mode control (SMC) procedure, the specific START value included in the INITIAL DIRECT TRANSFER message is used. A RNC of this third embodiment method is nearly identical the RNC 320r of FIG. 10, but for changes to the program code 321p to provide support for the third embodiment method. Similarly, a UE of the third embodiment method is nearly identical the UE 100 of FIG. 7, but for changes to the program code 107 to provide support for the third embodiment method. Such changes to the program code 107 and 321p should be well within the means of one reasonably skilled in the art after reading the following detailed description. Please refer to FIG. 13 and FIG. 14. FIG. 13 is a simple block diagram of a UE 500 and a wireless communications system 410 according to the third embodiment method. FIG. 14 is a message sequence chart illustrating the third embodiment method. As the behavior of a third embodiment RNC 420r differs from that of the prior art RNC 22, a UTRAN 420 composed of such RNCs 420r will similarly behave differently from the UTRAN 20 of the prior art, and hence the invention wireless communications system 410 will differ from that of the prior art wireless system 10. Similarly, the behavior of the UE 500, as determined by the program code within the UE 500, differs from that of the prior art UE 40 to support the third embodiment method. In the third embodiment method, the UE 500 is assumed to be in wireless communications with the UTRAN 420. The UE 500 has established an SRB 508s, which utilizes an RLC-AM connection, and which has a peer SRB 428s on the UTRAN 320 side. The UE 500 composes an INITIAL DIRECT TRANSFER (IDT) message 507m. The INITIAL DIRECT TRANSFER message 507m contains a START value 507s for a domain x, which may be either the PS domain 130p or the CS domain 130c within the CN 130. The START value 507s is calculated in the normal manner; that is, by considering all RBs 508 within the domain x, selecting the greatest HFN (including RLC 72 HFNs 76r, 76t, and RRC 80 HFNs) from all of these RBs 508, and adding two to the greatest HFN value to generate the START value 507s. The RRC layer 80 then sends the INITIAL DIRECT TRANSFER message 507m to the RLC layer 72 for transmission to the UTRAN 420 (and, by extension, the present invention RNC 420r). At this time, the UE 500 sets an “IDT value for SMC procedure” START value 527 to be equal to the START value 507s in the INITIAL DIRECT TRANSFER message 507m. This value 527 is used to hold the START value 507s transmitted in that last INITIAL DIRECT TRANSFER message 507m sent to the UTRAN 420. The RLC layer 72 breaks the INITIAL DIRECT TRANSFER message 507m into one or more RLC-AM PDUs 50, and transmits these RLC-AM PDUs 50 to the UTRAN 420 along the SRB 508s. Each successfully received RLC-AM PDU 50 is acknowledged by the peer SRB 428s. As in the previous examples, it is assumed that the INITIAL DIRECT TRANSFER message 507m is segmented into three RLC-AM PDUs 50, two of which are successfully transmitted and acknowledged, and the third of which is lost in transmission and so not acknowledged. At some time after the third RLC-AM PDU 50 is lost, the RRC layer 80 of the UE 500 composes a second RRC message 509m, which also contains a START value 509s for the domain x (such as a CELL UPDATE message), and which is not an INITIAL DIRECT TRANSFER message. The RRC layer 80 of the UE 500 calculates the START value 509s in the normal manner, and thus generates a value larger than the START value 507s in the INITIAL DIRECT TRANSFER message 507m. The second RRC message 509m is then sent by the UE 500 to the UTRAN 420, and subsequently confirmed by the UTRAN 420. The UTRAN 420 does not, however, store the START value 509s held within the second RRC message 509m as a “IDT value for SMC procedure” START value 427. This action is performed only for reception of INITIAL DIRECT TRANSFER messages. Thereafter, the third and final RLC-AM PDU 50 of the INITIAL DIRECT TRANSFER message 507m is finally successfully transmitted to the UTRAN 420 and acknowledged. The UTRAN 420 thus receives the INITIAL DIRECT TRANSFER message 507m after the second RRC message 509m. At this time, the UTRAN 420 sets the “IDT value for SMC procedure” START value 427 to be equal to the START value 507s in the INITIAL DIRECT TRANSFER message 507m. Hence, the “IDT value for SMC procedure” START value 427 is identical to the “IDT value for SMC procedure” START value 527. A Security Mode Command procedure is subsequently initiated by the UTRAN 420, which the UTRAN 420 applies the “IDT value for SMC procedure” START value 427, which is the START value 507s from the INITIAL DIRECT TRANSFER message 507m, to set the HFNs for the COUNT-C and COUNT-I values of the RBs 428, 428s within the domain x. The UE 500 uses the “IDT value for SMC procedure” START value 527 to set the HFNs of the COUNT-C and COUNT-I values within the domain x. Ciphering and integrity protection thus perform successfully within domain x.

In contrast to the prior art, the present invention ensures that START values can be synchronized even when RRC messages are unexpectedly out of sequence with respect to their transmission and reception order. In the first embodiment, the present invention causes the UE to continue using the same START value for RRC messages until reception of an RRC message containing that START value is confirmed. In the second embodiment, the UTRAN only updates its most recently received START value if the received START value in an RRC message exceeds the most recently received START value. In the third embodiment, the START values used to perform a Security Mode procedure are obtained exclusively from those values most recently transmitted and received in an INITIAL DIRECT TRANSFER message.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for synchronizing START values in a wireless network, the wireless network comprising a radio network controller (RNC) in wireless communications with user equipment (UE), the method comprising:
the UE generating a first START value according to a predefined method utilizing at least a hyperframe number of at least a radio bearer;
the UE composing a first message containing the first START value;
the UE transmitting the first message to the RNC;
prior to receiving confirmation from the RNC of successful reception of the first message, the UE composing a second message containing the first START value; wherein at the time of composing the second message, the predefined methodyields a second START value for the UE that does not equal the first START value; and the UE transmitting the second message to the RNC.

2. The method of claim 1 wherein in response to not receiving the confirmation from the RNC of the successful reception of the first message, the UE utilizes the first START value as an embedded START value in the second message.

3. The method of claim 1 further comprising performing a Security Mode procedure after the UE transmits the second message to the RNC; wherein the UE utilizes the first START value in both the first message and the second message.

4. The method of claim 3 wherein a Radio Resource Control (RRC) layer within the UE generates the first message and the second message.

5. The method of claim 4 wherein the first message is an INITIAL DIRECT TRANSFER message, and the second message is a CELL UPDATE message.

6. A wireless device comprising a processor and memory, the memory containing program code executable by the processor for performing the following steps:
generating a first START value according to a predefined method utilizing at least a hyperframe number of at least a radio bearer;
composing a first message containing the first START value;
transmitting the first message to a radio network controller (RNC);
detecting confirmation from the RNC of successful reception of the first message;
in response to being prior to detecting confirmation from the RNC of the successful reception of the first message, composing a second message containing the first START value; wherein at the time of composing the second message, the predefined method yields a second START value for the UE that does not equal the first START value; and
transmitting the second message to the RNC.

7. The wireless device of claim 1 wherein the program code is further capable of performing a Security Mode procedure after the wireless device transmits the second message to the RNC; wherein the wireless device utilizes the first START value in both the first message and the second message.

8. The wireless device of claim 7 wherein the first message is an INITIAL DIRECT TRANSFER message, and the second message is a CELL UPDATE message.

9. A method for synchronizing START values in a wireless network, the wireless network comprising a radio network controller (RNC) in wireless communications with user equipment (UE), the method comprising:
the RNC receiving a first message containing a first START value from the UE;
comparing the first START value to a previously received START value; and
in response to comparing the first START value to the previously received START value, not utilizing the first START value to change the previously received START value if the first START value is less than the previously received START value.

10. The method of claim 9 further comprising:
the RNC receiving a second message containing a second START value from the UE;
comparing the second START value to the previously received START value; and
in response to comparing the second START value to the previously received START value, changing the previously received START value according to the second START value if the second START value exceeds the previously received START value.

11. The method of claim 10 wherein the previously received START value is set equal to the second START value.

12. The method of claim 11 further comprising:
the UE generating the first START value according to a predefined method utilizing at least a hyperframe number of at least a radio bearer;
the UE composing the first message containing the first START value;
the UE transmitting the first message to the RNC;
the UE generating the second START value according to the predefined method, wherein the second START value exceeds the first START value;
the UE composing the second message containing the second START value;
the UE transmitting the second message to the RNC;
the RNC receiving the second message and saving the second START value as the previously received START value; and
the RNC subsequently receiving the first message and not using the first START value as the previously received START value.

13. The method of claim 12 wherein a Radio Resource Control (RRC) layer within the UE generates the first message and the second message.

14. The method of claim 13 wherein the first message is an INITIAL DIRECT TRANSFER message, and the second message is a CELL UPDATE message.

15. The method of claim 9 further comprising utilizing the previously received START value to perform a Security Mode procedure with the UE.

16. A wireless device comprising a processor and memory, the memory containing a previously received START value for performing a Security Mode procedure, and program code executable by the processor for performing the following steps:
receiving a first message containing a first START value from another wireless device;
comparing the first START value to the previously received START value; and
in response to comparing the first START value to the previously received START value, not utilizing the first START value to change the previously received START value if the first START value is less than the previously received START value.

17. The wireless device of claim 16 wherein the program code is further capable of performing the following steps:
receiving a second message containing a second START value from the other wireless device;
comparing the second START value to the previously received START value; and
in response to comparing the second START value to the previously received START value, changing the previously received START value according to the second START value if the second START value exceeds the previously received START value.

18. The wireless device of claim 17 wherein the previosuly received START value is set equal to the second START value.

19. The wireless device of claim 16 wherein the first message is an INITIAL DIRECT TRANSFER message, and the second message is a CELL UPDATE message.

20. The wireless device of claim 16 wherein the program code is further capable of utilizing the previously received START value to perform the Security Mode procedure with the other wireless device.

21. A method for synchronizing START values in a wireless network, the wireless network comprising a radio network controller (RNC) in wireless communications with user equipment (UE), the method comprising:
the UE exclusively using a START value embedded in an INITIAL DIRECT TRANSFER message most recently transmitted to the RNC from the UE when performing a Security Mode procedure with the RNC; and
the RNC exclusively using a START value embedded in an INITIAL DIRECT TRANSFER message most recently received from the UE when performing the Security Mode procedure with the UE.

22. The method of claim 21 further comprising:
the UE generating a first START value according to a predefined method utilizing at least a hyperframe number of at least a radio bearer;
the UE composing an INTIAL DIRECT TRANSFER message containing the first START value;
the UE transmitting the INTIAL DIRECT TRANSFER message to the RNC;
the UE generating a second START value according to the predefined method, wherein the second START value exceeds the first START value;
the UE composing a second message containing the second START value;
the UE transmitting the second message to the RNC;
a Radio Resource Control (RRC) layer within the RNC receiving the second message;
the RRC layer within the RNC receiving the INTIAL DIRECT TRANSFER message after receiving the second message; and
the RNC and the UE subsequently performing a Security Mode procedure utilizing the first START value.

23. The method of claim 22 wherein the second message is a CELL UPDATE message.

24. A wireless device comprising a processor and memory, the memory containing a synchronizing START value for performing a Security Mode procedure, and program code executable by the processor for performing the following steps:
receiving an INITIAL DIRECT TRANSFER message containing a first START value from another wireless device and exclusively setting the synchronizing START value to the first START value so that the synchronizing START value holds values only obtained from received INITIAL DIRECT TRANSFER messages; and
performing a Security Mode procedure with the other wireless device using the synchronizing START value.

25. A wireless device comprising a processor and memory, the memory containing a synchronizing START value for performing a Security Mode procedure, and program code executable by the processor for performing the following steps:
transmitting an INITIAL DIRECT TRANSFER message containing a first START value to another wireless device and exclusively setting the synchronizing START value to the first START value so that the synchronizing START value holds values only obtained from transmitted INITIAL DIRECT TRANSFER messages; and
performing a Security Mode procedure with the other wireless device using the synchronizing START value.
